(19) United States
(12) Patent Application Publication
(10) Pub. No.: US 2021/0305543 A1
(43) Pub. Date: Sep. 30, 2021

(54) RECHARGEABLE BUTTON CELL

(71) Applicant: FUJIAN NANPING YANPING DISTRICT NANFU NEW ENERGY TECHNOLOGY CO., LTD., Nanping (CN)

(72) Inventors: Haitao CHANG, Nanping (CN); Yongfeng YE, Nanping (CN); Huazao XU, Nanping (CN)

(21) Appl. No.: 16/910,351

(22) Filed: Jun. 24, 2020

(30) Foreign Application Priority Data
Mar. 27, 2020 (CN) 202020424416.7

(51) Int. Cl. H01M 2/02; H01M 2/08; H01M 2/26; H01M 10/04

(52) U.S. Cl. CPC H01M 2/0227; H01M 2/08; H01M 2220/30; H01M 2/0222; H01M 10/0427; H01M 2/26

(57) ABSTRACT

The present invention discloses a rechargeable button cell, which includes an anode shell, a cathode shell, and a coiled electric core which is located in a receiving cavity and includes an anode tab and a cathode tab. The anode tab includes a first connection portion, and a first folding portion that is folded from the first connection portion to the lower side of the first connection portion. The first folding portion is welded to a bottom wall from the interior of the anode shell. The cathode tab includes a second connection portion, and a second folding portion that is folded from the second connection portion to the upper side of the second connection portion. The second folding portion is welded to a top wall from the interior of the cathode shell.

### CROSS-REFERENCE TO RELATED PATENT APPLICATION

This application claims priority to Chinese Patent Application No. CN202020424416.7 filed in China on Mar. 27, 2020. The disclosure of the above application is incorporated herein in its entirety by reference.

### FIELD

The present invention relates to the technical field of cells, and more particularly, to a rechargeable button cell.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing rechargeable button cell generally has a ratio of diameter to thickness greater than 1. Depending on different product requirements, button cells are generally packaged in two package forms, i.e., a soft bag package form or a hard shell package form. The hard shell package form in which a metal shell is used will have higher safety and dimensional stability, followed by better stability of the cell performances.

The hard shell package structure generally includes two half shells that form a receiving cavity, and a sealing structure is provided between the two half shells to avoid liquid leakage. Two tabs of an electric core in the cell are welded to the two half shells respectively. In some of existing rechargeable button cells, tabs are welded from the outside of a case, and this welding form greatly affects the structural strength of the half shells, resulting in a risk of liquid leakage after long-term use. Although in some of existing rechargeable button cells, tabs are not welded from the outside of the case, the welding operation is inconvenient due to the size limitation of the half shells, thereby affecting the production efficiency of the cell and also affecting the conductivity caused by the occurrence of a phenomenon that a welding structure of the tabs is unstable.

Therefore, there is a need for a rechargeable button cell to at least partially solve the above-mentioned problems.

### SUMMARY

A series of concepts in a simplified form are introduced in the summary of the present invention, which will be explained in further detail in the detailed description. The summary of the present invention does not mean trying to define the key features and necessary technical features of the claimed technical solution, nor does it mean trying to determine the protection scope of the claimed technical solution.

The technical solution adopted by the present invention is to provide a rechargeable button cell, which comprises:

an anode shell which comprises a flat bottom wall, and an anode side wall extending upward from the circumferential edge of the bottom wall;

a cathode shell which comprises a flat top wall, and a cathode side wall extending downward from the circumferential edge of the top wall, wherein a receiving cavity is formed between the cathode shell and the anode shell;

a sealing ring which is provided between the anode side wall and the cathode side wall in a sleeving manner; and

a coiled electric core which is located in the receiving cavity and comprises an anode tab and a cathode tab, wherein

the anode tab comprises a first connection portion that extends in a radial direction of the rechargeable button cell, and a first folding portion that is folded from the first connection portion to the lower side of the first connection portion and extends in the radial direction, wherein the first folding portion is welded to the bottom wall from the interior of the anode shell; and

the cathode tab comprises a second connection portion that extends in the radial direction, and a second folding portion that is folded from the second connection portion to the upper side of the second connection portion and extends in the radial direction, wherein the second folding portion is welded to the top wall from the interior of the cathode shell.

The coiled electric core comprises a winding core and an electrode winding sleeving the winding core, wherein the electrode winding comprises an anode piece, a cathode piece, and a separator that separates the anode piece from the cathode piece.

Optionally, a projection of a welding position of the first folding portion of the anode tab on a radial section is located in a projection area of the electrode winding on the radial section; and/or

a projection of a welding position of the second folding portion of the cathode tab on a radial section is located in a projection area of the electrode winding on the radial section.

Optionally, the projection of the welding position of the first folding portion of the anode tab on the radial section is located in a projection area of the winding core on the radial section; and/or

the projection of the welding position of the second folding portion of the cathode tab on the radial section is located in a projection area of the winding core on the radial section.

Optionally, the first connection portion is connected to the anode piece located at the radially outermost layer of the coiled electric core; and/or

the second connection portion is connected to the cathode piece located at the radially outermost layer of the coiled electric core.

Optionally, a welding point and/or a welding surface of the first folding portion does not penetrate through the bottom wall; and/or

a welding point and/or a welding surface of the second folding portion does not penetrate through the bottom wall.

Optionally, the first folding portion is resistance welded to the bottom wall.

Optionally, the second folding portion is laser-welded or ultrasonically welded to the top wall.

Preferably, the anode side wall is provided with a recess that is formed by extrusion and recessed inward in the radial direction.

Preferably, the first connection portion stretches across the lower surface of the winding core, and the second connection portion stretches across the upper surface of the winding core.

The rechargeable button cell provided by the present invention has the following advantages:

the anode tab is welded from the interior of the anode shell, and the cathode tab is welded from the interior of the cathode shell, such that the anode shell and the cathode shell achieve a good structural strength, without a phenomenon of liquid leakage after long-term use; and

by folding the anode tab and the cathode tab, the formed folding portions are welded, such that the welding operation is easily carried out. Therefore, the production efficiency of the rechargeable button cell can be improved, and the welding fastness of the two tabs is ensured, thereby improving the conductivity of the rechargeable button cell.

### BRIEF DESCRIPTION OF THE DRAWINGS

The following accompanying drawings are used here as part of the present invention to understand the present invention. In the drawings,

FIG. 1 is a sectional view of a preferred embodiment of the present invention;

FIG. 2 is an enlarged schematic diagram of part A in FIG. 1; and

FIG. 3 is an enlarged schematic diagram of part B in FIG. 1.

### DETAILED DESCRIPTION

In the following description, a large number of specific details are given in order to provide a more thorough understanding of the present invention. However, it is apparent to those skilled in the art that the present invention can be implemented without one or more of these details. In other instances, some of the technical features well known in the art are not described in order to avoid the confusion with the present invention.

Hereinafter, specific embodiments of the present invention will be described in detail with reference to the accompanying drawings. These accompanying drawings show representative embodiments of the present invention, but limit the present invention.

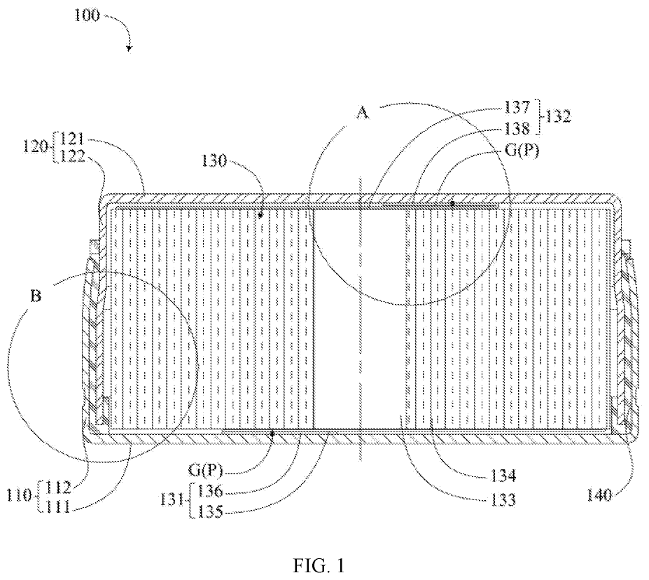

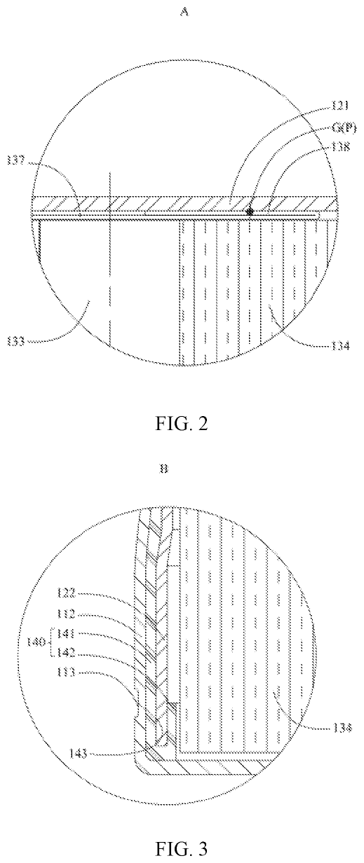

FIGS. 1 to 3 show a preferred embodiment of the present invention.

As shown in FIG. 1, the rechargeable button cell 100 may comprise an anode shell 110, a cathode shell 120 and a coiled electric core 130. The cathode shell 120 may cover the anode shell 110 to form a receiving cavity between the cathode shell 120 and the anode shell 110. The coiled electric core 130 is provided in the receiving cavity. The coiled electric core 130 comprises an anode tab 131 and a cathode tab 132. The anode tab 131 may be connected to the lower end of the coiled electric core 130 and can be welded to the anode shell 110. The cathode tab 132 may be connected to the upper end of the coiled electric core 130 and can be welded to the cathode shell 120.

It should be noted that directional terms such as “upper”, “lower”, “above”, “below”, “up”, “down”, “upward”, “downward” and the like used in the description of various components and parts of the rechargeable button cell 100 herein are described in terms of the upright placement of the rechargeable button cell 100.

Specifically, the anode shell 110 may comprise a flat bottom wall 111, and an anode side wall 112 extending upward from the circumferential edge of the bottom wall 111. The upper end of the anode side wall 112 may define a top opening. The cathode shell 120 may comprise a flat top wall 121, and a cathode side wall 122 extending downward from the circumferential edge of the top wall 121. The lower end of the cathode side wall 122 may define a bottom opening. The coiled electric core 130 can enter the cathode shell 120 from the bottom opening thereof, and the cathode shell 120 can enter the anode shell 110 from the top opening thereof. Therefore, the cathode side wall 122 can be located inside the anode side wall 112. Both the anode shell 110 and the cathode shell 120 are made of a metal material, for example, a stainless steel material such as 304 or 316L.

The anode tab 131 may be located above the bottom wall 111, and welded to the bottom wall 111 from the interior of the anode shell 110 in a state where the cathode shell 120 does not cover the anode shell 110. The cathode tab 132 may be located below the top wall 121, and welded to the top wall 121 from the interior of the cathode shell 120 in a state where the cathode shell 120 does not cover the anode shell 120. In this embodiment, the welding of the two tabs can be completed before the cathode shell 120 covers the anode shell 110.

Further, the coiled electric core 130 may further comprise a winding core 133, and an electrode winding 134 sleeving the winding core 133. The electrode winding 134 may comprise an anode piece, a cathode piece, and a separator that separates the anode piece from the cathode piece. The anode piece, the separator and the cathode piece are wound onto the winding core 133 together.

The end of the anode tab 131 may be folded, and the folded portion is welded. Specifically, the anode tab 131 may comprise a first connection portion 135 and a first folding portion 136, which extend in a radial direction of the rechargeable button cell 100. The first connection portion 135 can be connected to the anode piece located at the radially outermost layer of the coiled electric core 130. The first folding portion 136 can be folded from the first connection portion 135 to the lower side of the first connection portion 135 and fit the bottom wall 111. The first folding portion 136 can be welded to the bottom wall 111 from the interior of the anode shell 110. Specifically, in the case that the rechargeable button cell 100 is assembled, the first folding portion 136 of the anode tab 131 is welded to the bottom wall 111 of the anode shell 110 from the interior of the anode shell 110 in a state where the cathode shell 120 does not cover the anode shell 110. A length dimension of the anode tab 131 is configured so that the first connection portion 135 can stretch across the lower surface of the winding core 133.

The end of the cathode tab 132 may also be folded, and the folded portion is welded. Specifically, the cathode tab 132 may comprise a second connection portion 137 and a second folding portion 138, which extend in the radial direction of the rechargeable button cell 100. The second connection portion 137 can be connected to the cathode piece located at the radially outermost layer of the coiled electric core 130. The second folding portion 138 can be folded from the second connection portion 137 to the upper side of the second connection portion 137 and fit the top wall 121. The second folding portion 138 can be welded to the top wall 121 from the interior of the cathode shell 120. Specifically, in the case that the rechargeable button cell 100 is assembled, the second folding portion 138 of the cathode tab 132 is welded to the top wall 121 of the cathode shell 120 from the interior of the cathode shell 120 in a state where the cathode shell 120 does not cover the anode shell 110. A length dimension of the cathode tab 132 is configured so that the second connection portion 137 can stretch across the upper surface of the winding core 133.

In this embodiment, a welding position P of the anode tab 131 preferably keeps away from an area below the winding core 133, and a welding position P of the cathode tab 132 preferably keeps away from an area above the winding core 133. Specifically, a projection of the welding position P of the first folding portion 136 on a radial section may be located in a projection area of the electrode winding 134 on the radial section. In addition, a projection of the welding position P of the cathode tab 132 on a radial section may be located in a projection area of the electrode winding 134 on the radial section.

Of course, if necessary and/or desired, the welding position P of the anode tab 131 may also be provided in an area below the winding core 133, and the welding position P of the cathode tab 132 may also be provided in an area above the winding core 133. Specifically, the projection of the welding position P of the first folding portion 136 on the radial section may be located in a projection area of the winding core 133 on the radial section. In addition, the projection of the welding position P of the cathode tab 132 on the radial section may be located in a projection area of the winding core 133 in the radial section.

The welding point and/or welding surface of the anode tab 131 may not penetrate through the anode shell 110, and the welding point and/or welding surface of the cathode tab 132 may not penetrate through the cathode shell 120. Specifically, the welding point and/or welding surface of the first folding portion 136 may not penetrate through the bottom wall 111, and the welding point and/or welding surface of the second folding portion 138 may not penetrate through the top wall 121.

Optionally, the anode tab 131 may be resistance welded to the anode shell 110. The cathode tab 132 may be laser-welded or ultrasonically welded to the cathode shell 120. Specifically, the first folding portion 136 may be resistance welded to the bottom wall 111. The second folding portion 138 is laser-welded or ultrasonically welded to the top wall 121. The number of welding points of resistance welding and laser welding may be greater than or equal to 2. Welding points or welding surfaces, the number of which is greater than or equal to 1, may be formed by ultrasonic welding.

In order to ensure a sealing effect, the rechargeable button cell 100 may further comprise a sealing ring 140. The sealing ring 140 can be provided between the anode side wall 112 and the cathode side wall 122 in a sleeving manner. Specifically, as shown in FIG. 3, the sealing ring 140 may comprise a sealing ring body 141 and a limiting wall 142. The limiting wall 142 can be located inside the sealing ring body 141 and connected to the lower end of the sealing ring body 141. A groove 143 with an upward opening can be formed between the limiting wall 142 and the sealing ring body 141. The lower end of the cathode side wall 122 is inserted into the groove 143. In order to enhance the sealing effect, at least one of the sealing ring 140, the anode shell 110 and the cathode shell 120 may be coated with a special sealant for button cells.

The anode side wall 112 may also be provided with a recess 113 that is recessed inward in a radial direction. The recess 113 is formed by extrusion, i.e., after the rechargeable button cell 100 is assembled, is formed by extrusion from the outside of the anode side wall 112. Any suitable extrusion process may be selected, such as a wire bonding process. In this way, a seal may be formed at the recess 113, so that the sealing effect can be enhanced.

The assembly process of the rechargeable button cell 100 in this embodiment is described as follows:

the sealing ring 140 sleeves the side wall of the cathode shell 120, and the second folding portion 138 formed by folding the cathode tab 132 is then welded to the top wall 121 of the cathode shell 120. Next, the electric core is loaded into the cathode shell 120, and after vacuum drying, the first folding portion 136 formed by folding the anode tab 131 is welded to the bottom wall 111 of the anode shell 110. Next, the cathode shell 120 and the electric core sleeved with the sealing ring 140 are loaded into the anode shell 110 together, and the cathode shell 120 covers the anode shell 110. Finally, the anode side wall 112 is extruded by a wire bonding process to form the recess 113, thereby completing the assembly.

According to the rechargeable button cell designed by the present invention, the anode tab is welded from the interior of the anode shell, and the cathode tab is welded from the interior of the cathode shell, such that the anode shell and the cathode shell achieve a good structural strength, without a phenomenon of liquid leakage after long-term use. By folding the anode tab and the cathode tab, the formed folding portions are welded, such that the welding operation is easily carried out. Therefore, the production efficiency of the rechargeable button cell can be improved, and the welding fastness of the two tabs is ensured, thereby improving the conductivity of the rechargeable button cell.

It should be understood that the above embodiments are merely for the purpose of illustration and explanation rather than limiting the present invention within the scope described thereby. Various transformations and modifications can be further made in accordance with the teachings of the present invention. These transformations and modifications are within the scope of the present invention as claimed.

What is claimed is:

1. A rechargeable button cell, comprising:
an anode shell which comprises a flat bottom wall, and an anode side wall extending upward from a circumferential edge of the bottom wall;
a cathode shell which comprises a flat top wall, and a cathode side wall extending downward from a circumferential edge of the top wall, wherein a receiving cavity is formed between the cathode shell and the anode shell;
a sealing ring which is provided between the anode side wall and the cathode side wall in a sleeving manner; and
a coiled electric core which is located in the receiving cavity and comprises an anode tab and a cathode tab, wherein
the anode tab comprises a first connection portion that extends in a radial direction of the rechargeable button cell, and a first folding portion that is folded from the first connection portion to a lower side of the first connection portion and extends in the radial direction, wherein the first folding portion is welded to the bottom wall from an interior of the anode shell; and
the cathode tab comprises a second connection portion that extends in the radial direction, and a second folding portion that is folded from the second connection portion to a lower side of the second connection portion and extends in the radial direction, wherein the second folding portion is welded to the top wall from an interior of the cathode shell.

2. The rechargeable button cell according to claim 1, wherein the coiled electric core comprises a winding core and an electrode winding sleeving the winding core, wherein the electrode winding comprises an anode piece, a cathode piece, and a separator that separates the anode piece from the cathode piece.

3. The rechargeable button cell according to claim 1, wherein
a projection of a welding position of the first folding portion on a radial section is located in a projection area of the electrode winding on the radial section.

4. The rechargeable button cell according to claim 1, wherein
a projection of a welding position of the second folding portion on a radial section is located in a projection area of the electrode winding on the radial section.

5. The rechargeable button cell according to claim 1, wherein
a projection of a welding position of the first folding portion on a radial section is located in a projection area of the winding core on the radial section.

6. The rechargeable button cell according to claim 1, wherein
a projection of a welding position of the second folding portion on a radial section is located in a projection area of the winding core on the radial section.

7. The rechargeable button cell according to claim 1, wherein
the first connection portion is connected to the anode piece located at a radially outermost layer of the coiled electric core.

8. The rechargeable button cell according to claim 1, wherein
the second connection portion is connected to the cathode piece located at a radially outermost layer of the coiled electric core.

9. The rechargeable button cell according to claim 1, wherein
at least one of a welding point and a welding surface of the first folding portion does not penetrate through the bottom wall.

10. The rechargeable button cell according to claim 1, wherein
at least one of a welding point and a welding surface of the second folding portion does not penetrate through the top wall.

11. The rechargeable button cell according to claim 1, wherein the first folding portion is resistance welded to the bottom wall.

12. The rechargeable button cell according to claim 1, wherein the second folding portion is laser-welded or ultrasonically welded to the top wall.

13. The rechargeable button cell according to claim 1, wherein the anode side wall is provided with a recess that is formed by extrusion and recessed inward in the radial direction.

14. The rechargeable button cell according to claim 1, wherein the first connection portion stretches across a lower surface of the winding core, and the second connection portion stretches across a upper surface of the winding core.
